(19) United States
(12) Patent Application Publication
(10) Pub. No.: US 2016/0230931 A1
(43) Pub. Date: Aug. 11, 2016

(54) BOIL-OFF-GAS MANAGEMENT AT HYDROGEN FUELING STATIONS

(71) Applicants: Wilfried-Henning Reese, Unterschleissheim (DE); Tobias Kederer, Pullach (DE); Simon Schäfer, Munich (DE); Michael Westermeier, Starnberg (DE); Johann Scheday, Baierbrunn (DE)

(72) Inventors: Wilfried-Henning Reese, Unterschleissheim (DE); Tobias Kederer, Pullach (DE); Simon Schäfer, Munich (DE); Michael Westermeier, Starnberg (DE); Johann Scheday, Baierbrunn (DE)

(21) Appl. No.: 14/865,883

(22) Filed: Sep. 25, 2015

(30) Foreign Application Priority Data
Oct. 28, 2014 (DE) 10 2014 015 987.6

(51) Int. Cl. F17C 7/04

(52) U.S. Cl. CPC F17C 7/04; F25J 2215/10; F25J 2220/04; F17C 2221/012; F17C 2227/0353; F17C 2227/0302

(57) ABSTRACT

A method for operating a hydrogen fueling station is described, wherein the latter exhibits at least at least one storage tank, which is used to store liquefied hydrogen, and in which boil-off gas at least occasionally accumulates, at least one cryogenic pump, which is used to compress the hydrogen to the desired dispensing pressure, at least one dispenser, through which the compressed hydrogen is dispensed, and lines that connect the aforementioned components. According to the invention, the boil-off gas that accumulates is at least partially used for cooling at least one component and/or line of the hydrogen fueling station and/or is at least partially catalytically combusted.

### CROSS REFERENCE TO RELATED APPLICATIONS

The present application claims priority from German Patent Application DE102014015987.6 field Oct. 28, 2014.

### BACKGROUND OF THE INVENTION

In the following, let the term “hydrogen fueling station” be understood to mean all facilities for dispensing compressed, gaseous hydrogen to pressure accumulator tanks present in mobile or stationary devices and used to store compressed hydrogen.

When storing liquefied hydrogen in hydrogen fueling stations, boil-off gas inevitably forms, and currently is either released into the atmosphere unused or fed to a so-called boil-off gas management system. For example, such a system exhibits a compressor, which compresses the boil-off gas, so that it can also be used to fill up a pressure accumulator tank, or a small cogeneration plant (Mink-BHKW) that burns the hydrogen.

However, releasing boil-off gas into the atmosphere is disadvantageous from both an ecological and economic standpoint. The compression of boil-off gas described above is comparatively complicated and cost-intensive in terms of plant engineering, and hence as a rule not economical. It is thus rather unlikely that this concept will be commercially used in hydrogen fueling stations.

### SUMMARY OF THE INVENTION

The object of the present invention is to perform a method for operating a hydrogen fueling station that avoids the aforementioned disadvantages.

Proposed for achieving this object is a method for operating a hydrogen fueling station, which is characterized by the fact that the boil-off gas that accumulates in the at least one storage tank is at least partially used for cooling at least one component and/or line of the hydrogen fueling station and/or is at least partially catalytically combusted.

The invention relates to a method for operating a hydrogen fueling station, exhibiting
at least one storage tank, which is used to store liquefied hydrogen, and in which boil-off gas at least occasionally accumulates;
at least one cryogenic pump, which is used to compress the hydrogen to the desired dispensing pressure;
at least one dispenser, through which the compressed hydrogen is dispensed, and
lines that connect the aforementioned components.

According to the invention, the thermal capacity of the boil-off gas is now used for cooling components and/or lines of the hydrogen fueling station. Electrical energy has previously been used for cooling and heating such components and lines.

The boil-off gas is advantageously at least partially used for cooling the line that connects the cryogenic pump and dispenser. Prescribed framework conditions require that this line be kept within a temperature ranging between −40 and

−33° C.

Alternatively or additionally, the boil-off gas is catalytically combusted. After adding oxygen or an oxygen-rich gas mixture, for example air, the boil-off gas can be combusted without flames in a suitable catalyzer.

The heat generated while catalytically combusting the boil-off gas is advantageously at least partially used to warm up the hydrogen compressed by the cryogenic pump, which is fed to the dispenser.

In a further development of the method according to the invention, it is proposed that the boil-off gas be catalytically combusted in a heat accumulator, preferably in an aluminum block, through which flows the hydrogen to be warmed up. As a result of this procedure, the pumped, cryogenic hydrogen, which has a temperature of between −220 and −60° C. at a pressure of 900 bar, can be warmed up to a desired temperature, e.g., of −40° C. The hydrogen in the boil-off gas is catalytically combusted to water with oxygen from the air being present or added. This water is sustainably released into the environment or atmosphere in the form of water vapor through a suitable chimney.

### BRIEF DESCRIPTION OF THE DRAWINGS

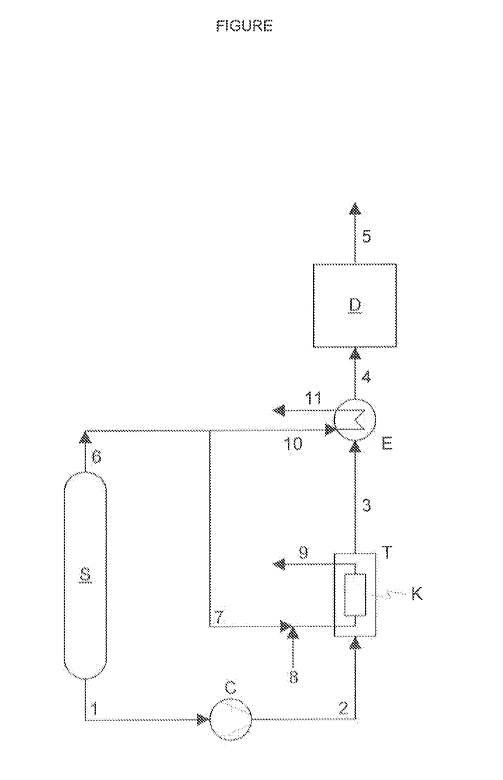

The method according to the invention for operating a hydrogen fueling station along with additional advantageous embodiments of the latter will be described in greater detail below based on the exemplary embodiment shown on FIG. 1.

### DETAILED DESCRIPTION OF THE INVENTION

FIG. 1 shows the essential components of a hydrogen fueling station, specifically a storage tank S, which is used to store liquefied hydrogen, a cryogenic pump C, which is used to compress the hydrogen to the desired dispensing pressure, and a dispenser D, with which the compressed hydrogen is dispensed to a mobile or stationary pressure accumulator tank. The lines 1 to 4 connecting the aforementioned components are also shown.

The liquefied hydrogen removed from the storage tank S via line 1 is compressed in the cryogenic pump C to the desired dispensing pressure, for example which lies between 750 and 900 bar. The compressed hydrogen, for example having a temperature of between −220 and −60° C., is guided via a line 2 through an aluminum block T, in which it is warmed up to a temperature of −40° C., for example. The compressed hydrogen is fed via line sections 3 and 4 to the dispenser D, from which it is fed to a pressure accumulator tank not shown on FIG. 1 via the fill line 5.

The boil-off gas 6 that accumulates in the storage tank S is divided into two partial flows 7 and 10 in the exemplary embodiment shown on FIG. 1. The first boil-off gas partial flow 7 is fed to a catalyzer K located in the aluminum block T after the addition of air 8, catalytically combusted in the latter, and released into the atmosphere through line 9. The heat that arises at the catalyzer K during catalytic combustion is stored in the aluminum block T, and warms up the hydrogen flow 2 streaming continuously or discontinuously through the aluminum block T. Should the heat content of the catalytically combusted boil-off gas partial flow 7 be inadequate for warming the hydrogen flow 2 up to the desired temperature, an additional heating device not shown on FIG. 1 must be provided, for example an electric heater.

The second boil-off gas partial flow 10 is used to cool (as denoted by heat exchanger E) the line sections 3 and 4 that connect the cryogenic pump C and dispenser D. As already described, these line sections must be kept at a temperature of between −40 and −33° C., for example, so as to enable compliance with the required framework conditions. After the line sections 3 and 4 have been cooled, the boil-off gas partial flow is also released into the environment via line 11 or also catalytically combusted.

The method according to the invention for operating a hydrogen fueling station makes it possible to use the energy and enthalpy contained in the boil-off gas. It is particularly advantageous that the quantity of electrical energy required while operating a hydrogen fueling station can be significantly reduced as a result of this use, since cooling and heating have previously essentially been realized with electrical cooling and heating devices. In addition, the method according to the invention for operating a hydrogen fueling station is simple in design, easy to control and scalable.

What we claim is:

1. A method for operating a hydrogen fueling station, wherein the hydrogen fueling station comprises:
at least one storage tank, which is used to store liquefied hydrogen, and in which boil-off gas at least occasionally accumulates;
at least one cryogenic pump, which is used to compress the hydrogen to the desired dispensing pressure;
at least one dispenser, through which the compressed hydrogen is dispensed, and
lines that connect the aforementioned components,
characterized in that the boil-off gas that accumulates in the at least one storage tank is at least partially used for cooling at least one component and/or line of the hydrogen fueling station and/or is at least partially catalytically combusted.

2. The method according to claim 1, characterized in that the heat generated while catalytically combusting the boil-off gas is at least partially used to warm up the hydrogen compressed by the cryogenic pump.

3. The method according to claim 1, characterized in that the boil-off gas is catalytically combusted in a heat accumulator through which flows the hydrogen to be warmed up.

4. The method according to claim 3, characterized in that the heat accumulator is an aluminum block.

5. The method according to claim 1, characterized in that the boil-off gas that accumulates in the at least one storage tank is at least partially used for cooling the line that connects the cryogenic pump and dispenser.
